(19) United States
(12) Patent Application Publication
(10) Pub. No.: US 2002/0196278 A1
(43) Pub. Date: Dec. 26, 2002

(54) Driving and information retrieving module capable of retrieving information over communication network and method of the same

(75) Inventor: Tiffany Chen, Hsin-Chu (TW)

Correspondence Address: LOWE HAUPTMAN GOPSTEIN GILMAN & BERNER, LLP, 1700 Diagonal Road, Suite 310, Alexandria, VA, 22314, US

(73) Assignee: MUSTEK SYSTEMS INC.

(21) Appl. No.: 09/884,143

(22) Filed: Jun. 20, 2001

(51) Int. Cl. G06F 13/00

(52) U.S. Cl. 345/748

(57) ABSTRACT

An apparatus as well as a method capable of retrieving and driving a peripheral device includes a processing unit, an input unit, a display unit and a communication unit. A retrieving and driving module is first installed in an electrical device. The electrical device along with the retrieving and driving module have a user interface module, a driving module, an information downloading module, an information displaying module. Under the operation of the modules, the electrical device can retrieve and download the information from a predetermined destination. At the same time, the electrical device is able to drive a peripheral device, such as a scanner, to scan under the command of the user.

### BACKGROUND OF THE INVENTION

1. Field of the Invention

The present invention generally relates to an advertisement message downloading module which is employed in an electrical device for downloading advertisements or useful information from the suppliers.

2. Background Description

Since the dramatic development and utilization of technologies in our daily life, now the computers have been employed in many ways, such as the document processing, image processing, going on the net and others. Sometimes, peripherals are needed to achieve such works. For examples, scanners, digital cameras and printers are very popular to be the proper peripheral devices.

Before users can use the peripheral devices, drivers are generally needed to be installed previously. After the installation of the drives for the peripheral devices respectively, the peripheral devices are therefore controllable and useful. FIG. 1 shows the function block diagram of an electrical device such as a computer. A peripheral device 3 is connected to the electrical device 1. The peripheral device 3 is a scanner, a digital camera or a printer. The electrical device 1 includes a processing unit 10, an input unit 12 and a display unit 14. The input unit 12 could be a keyboard or a mouse for inputting purposes. The display unit 14 could be a CRT monitor or a LCD monitor for displaying the inputted data from the inputting unit 12. The processing unit 10 at least includes an interface module 101 and a driving module 103 which are a firmware. When the user installs the interface module 101 and the driving module 103 in the processing unit 10, the electrical device would have the functions performed by the interface module 101 and the driving module 103. The driving module 103 is for recognizing the peripheral device 3 and further for registering and controlling the recognized peripheral device 3. In this case, the peripheral device 3 is installed and connected to the electrical device 1. The interface module 101 provides a user interface displayed on the display unit 14 as shown in FIG. 2. The electrical device 1 further includes an operation system 20 such as MICROSOFT WINDOWS. The interface will therefore be displayed under the operation system 20. By inputting the data or adjusting parameters, the user can control the peripheral device 3 via the electrical device 1.

In view of the above, in case of the peripheral device is a scanner and the electrical device is a computer, the computer will recognize the scanner after the installation of the interface module 103 and the driving module 101. The user may call the interface module 101 for inputting or adjusting proper parameters. In this case, a user interface 30 is shown on the monitor 14 of the computer. The user interface contains a start button 301 and a preview window 303. The user may click the start button 301 after inputting proper parameters for controlling purposes, to begin scanning processes. Generally, this kind of operation to a scanner is widely known by present users.

However, due to convenience of the Internet, computer users would like to connect their computers to the Internet in order to enjoy the blooming information provided on the Internet. In this case, it would be great if the information or data would be downloaded to the computer automatically or manually during scanning and displayed on the user interface 30 of scanning rather than to search or open a browser software to review some specific information. Because the manufacturers of peripheral devices would provide some promotion with great price deal, or update the drivers sometimes, it would be welcome to the user if this kind of information would be downloaded to the computer. In this regard, the user would not need to spend time on researching and finding the promotion or update patches or drivers, nor open a browser to access specific web pages often.

### SUMMARY OF THE INVENTION

It is therefore an object of the present invention to provide a driving module for downloading advertisement messages. The downloading module is further able to drive a peripheral device along with the ability for downloading messages. In this case, the manufacturer may actively provide information, such as the sale promotion, updated drivers or relative product data, directly to users. When the user starts the driving module, the driving module will drive the peripheral device and download the relative information to users as well.

### BRIEF DESCRIPTION OF THE DRAWINGS

The foregoing and other objects, aspects and advantages will be better understood from the following detailed description of a preferred embodiment of the invention with reference to the drawings, in which:

FIG. 1 shows the function block diagram of a prior known driving module;

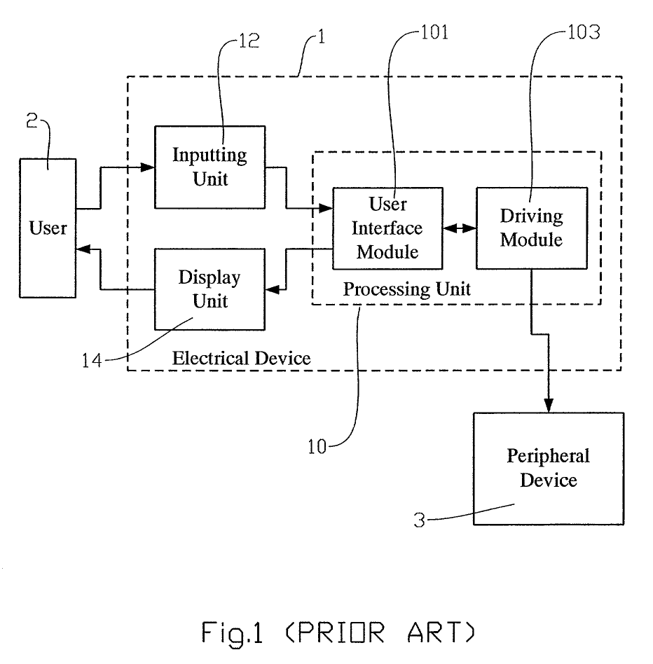

FIG. 2 demonstrates the screen display of the user interface of the prior known driving module;

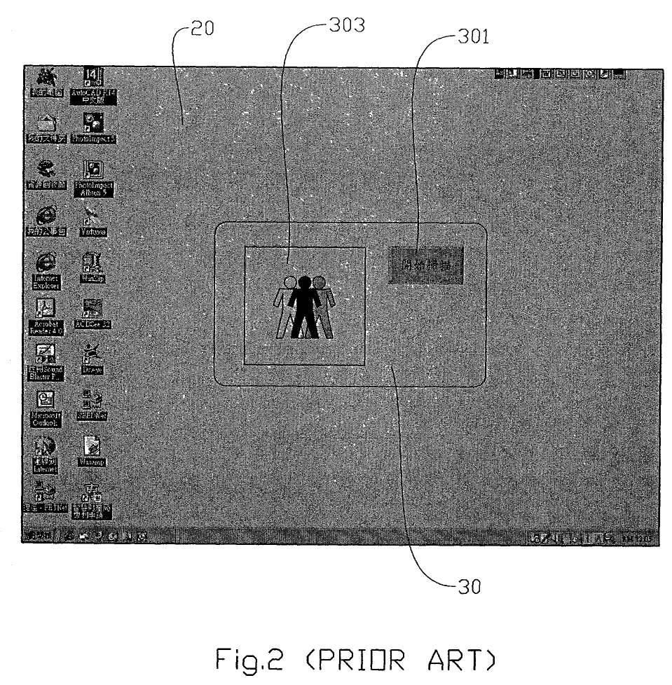

FIG. 3 shows the function block diagram of the present invention;

FIG. 4 demonstrates the screen display of the user interface of the present invention; and

FIG. 5 shows the user interface of another embodiment of the present invention.

### DETAILED DESCRIPTION OF A PREFERRED EMBODIMENT OF THE INVENTION

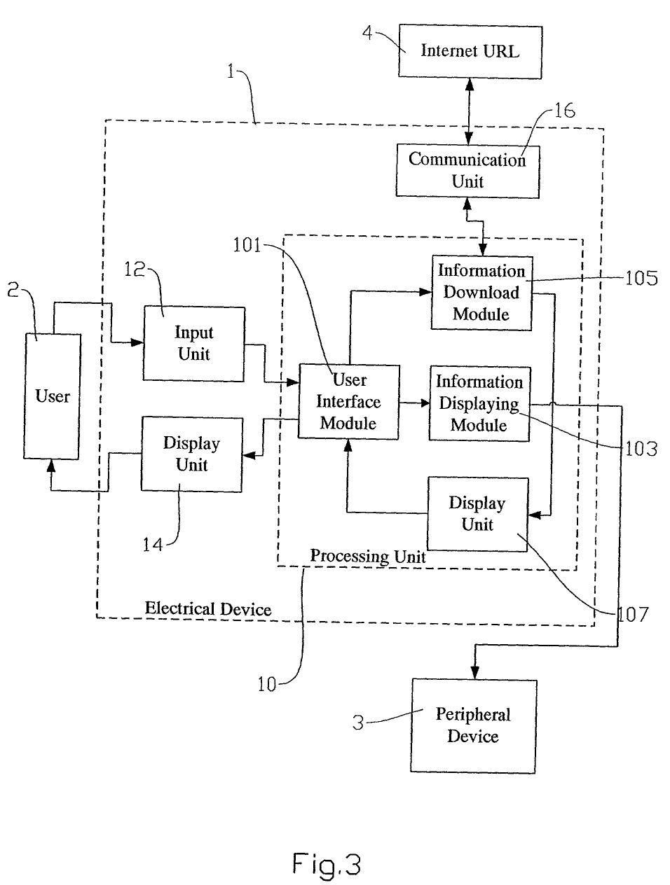

Please refer to FIG. 3. FIG. 3 shows the function block diagram demonstrating the electrical system with the driving module. The electrical device 1 connects a peripheral device 3. The peripheral device 3 could be a scanner, a digital camera or a printer for this example. The electrical device 1 may be a computer. The electrical device 1 includes a processing unit 10, an input unit 12, a display unit 14 and a communication unit 16. The input unit 12 may be a keyboard (not shown) or a mouse (not shown) for inputting data or instructions from user 2. The display unit 14 is a CRT monitor (not shown) or a liquid crystal display (not shown) for displaying the information provided to the user 2. Further, the processing unit 10 contains at least a user interface module 101, a driving module 103, an information downloading module 105 and an information displaying module 103. The four modules are written by programers and installed in the electrical device 1. After successful installation, the electrical device 1 would have the ability to conduct the functions specified of the four modules. For instance, the electrical device 1 with the installed driving module 103 would recognize the peripheral device 3.

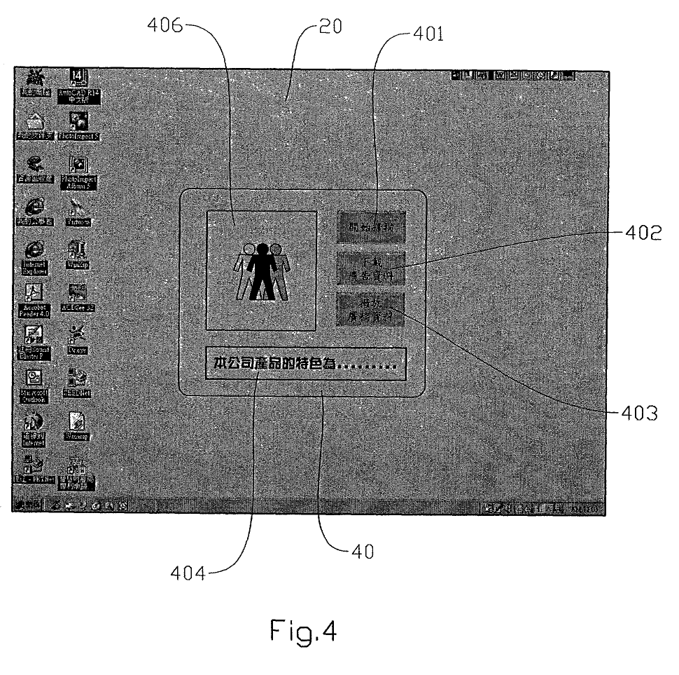

The user interface module 101 provides a user interface 40 shown on the display unit 14 as shown in FIG. 4. The electrical device 1 also includes an operation system 20 having an interface shown on the display unit 14. The user interface 40 is therefore operated under the operation system 20. Under the user interface 40, there are a driving button, an information downloading button 402, an information revealing button 403, an information area 404 and a preview window 406. When the user presses the driving button 103, the peripheral device 3 will be activated and operated. The user may preview the result in the preview window 406 and read the information, such as promotion or advertisement provided by the manufacturer, regarded to the peripheral device 3 at the same time.

When the user presses the information downloading button 402, the information downloading module 105 will connect a specific location for downloading a specific information. The specific location is a specific data storage or a specific Internet URL 4 (Uniform Resource Locator). If the specific location is the URL, the information downloading module 105 will connect the URL via the communication module 4. The URL is included in the information downloading module 105, the URL addresses may be the addresses of web sites of the manufacturer, dealers, agents or other related information providers. For example, the manufacturers have to place a specific information on the specific Internet address for the information downloading module 105 to retrieve. When the specific information is retrieved by the information downloading module 105, the specific information will be downloaded and stored in a storage of the electrical device 1 (the storage is not shown in the Figure), or the information on the specific address will still be kept over the Internet for further needs to download newly updated information. On the other concern, there could be no information downloading button 402. In this case, when the user opens the user interface 40, the information downloading module 105 will connect the URL 4 through the communication unit 16 for downloading a specific information over a communication network.

When the use clicks the information revealing button 403, the display unit 107 will display the downloaded information in the information area 404. The demonstration method of the information area 404 would be similar to the well-known HTML (Hyper Text Markup Language) and the browsing program application would be similar to the well-known browsers such as the Explorer or the Navigator. In this case, the information area will be able to show the texts, images, sounds, movies, clips with Flash supported. Besides, the support of Hyperlink function enables the user to access the web site when the user clicks the advertisement. In this case, the downloaded information will not be limited to the information downloading module 105 but be expanded to the other browsers such as the Explorer or the navigator. On the other hand, the user interface 40 can be developed to a window without the information revealing button 403. So that the display unit 107 will connect to the specific web site or the advertisement information previously stored in the storage (not shown) of the electrical device 1 when the user starts the user interface 40. Thus, the advertising information will be shown in the information area 404 automatically.

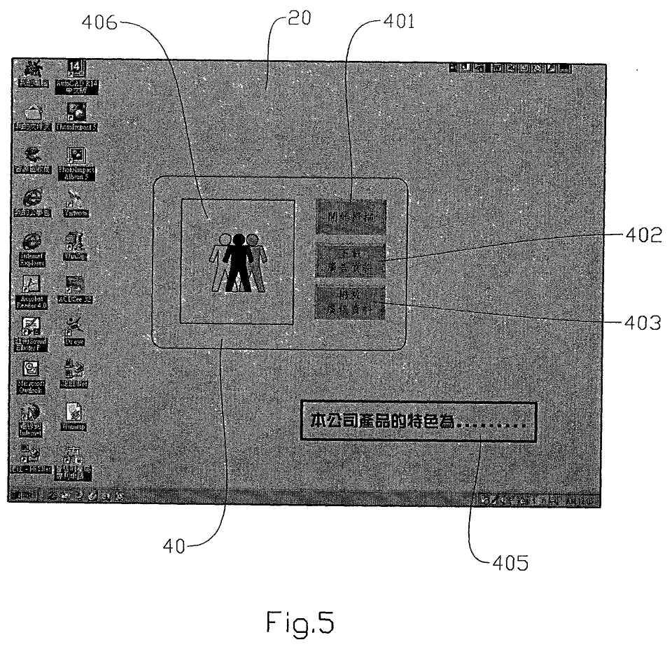

FIG. 5 shows another design of the information area 404. An independent advertisement window 405 is separated from the user interface 40. In this case, the user will not see the advertisement information when the user does not click the information revealing button 403. The advertisement window 405 will be opened only when the user clicks the information button 403.

As discussed in the above, the driving module of the present invention not only serve the ordinary functions of a driving module, but also serve the function of downloading advertisements or promotions. The advertisement information can be first downloaded to the storage of the electrical device for later reviewing or accessed via a browser. For instance, the employment of the driving module of the present invention will enable the manufactures of scanners to provide the services, promotions, advertisement, update information or drivers at users' finger tips, rather than to search the known destination on the Internet. In the way, the user can obtain the information from a specific information provider when the user conducts scanning. A detailed method of the foregoing is illustrated as follows:

1) The user start the driving module from the command panel of the operation system. The diving module displays the user interface on the monitor;

2) When the user clicks the information revealing button or the user interface is opened, the information downloading module will download an advertisement or specific information from a predetermined location on the Internet;

3) When the user clicks the information revealing button, the information will be shown in an information area or an advertisement window;

4) The use is able to conduct scanning processes during any time when the information is downloaded or displayed.

Although preferred embodiments of the present invention have been described in the forgoing description and illustrated in the accompanying drawings, it will be understood that the invention is not limited to the embodiments disclosed, but is capable of numerous rearrangements, modifications, and substituting of parts and elements without departing from the spirit and scope of the invention. Accordingly, the present invention is intended to encompass such rearrangements, modifications, and substitutions of parts and elements as fall within the scope of the appended claims.

1. A driving and information retrieving module capable of retrieving information over communication network in an electrical device which includes a display unit and a processing unit, comprising:
a driving module for driving a peripheral device which is connected to said electrical device;
a user interface module for display a user interface on said display unit;
an information downloading module for downloading information from a specific destination; and
an information displaying module for displaying said information on said display unit.

2. The driving and information retrieving module of claim 1, wherein said electrical device further comprising an input unit for entering data to said electrical device.

3. The driving and information retrieving module of claim 1, wherein said user interface further comprising a driving button for instructing said peripheral device to conduct.

4. The driving and information retrieving module of claim 1, wherein said electrical device further comprising a communication unit for connecting to said specific destination.

5. The driving and information retrieving module of claim 1, wherein said information downloading module connects said predetermined destination after said user interface is started.

6. The driving and information retrieving module of claim 1, wherein said user interface further comprising:
an information downloading button, located in said user interface, for initiating said information downloading module to retrieve said information to said electrical device.

7. The driving and information retrieving module of claim 5, wherein said predetermined destination is an address of a web page.

8. The driving and information retrieving module of claim 5, wherein said electrical device comprises a storage device for storing said information.

9. The driving and information retrieving module of claim 1, wherein said information displaying module displays said information on said display unit automatically.

10. The driving and information retrieving module of claim 1, wherein said user interface comprises an information revealing button, placed on said user interface, for initiating said information shown on said display unit.

11. The driving and information retrieving module of claim 10, wherein said information displaying module displays said information on an information area of said user interface.

12. The driving and information retrieving module of claim 10, wherein said information displaying module displays said information on an advertisement window.

13. The driving and information retrieving module of claim 11, wherein said information includes a function of hypertext link.

14. The driving and information retrieving module of claim 12, wherein said information includes a function of hypertext link.

15. The driving and information retrieving module of claim 1, wherein said electrical device is a computer.

16. The driving and information retrieving module of claim 1, wherein said peripheral device is a scanner.

17. The driving and information retrieving module of claim 2, wherein said input unit is a keyboard.

18. The driving and information retrieving module of claim 2, wherein said input unit is a mouse device.

19. A method of driving and retrieving information comprising the steps of:
(1) starting a retrieving and downloading module, installed in an electrical device, for opening a user interface module to generate a user interface, wherein said user interface is displayed on a display unit;
(2) an information downloading module of said retrieving and downloading module accessing a predetermined destination and therefore downloading information;
(3) an information displaying module of said retrieving and downloading module displaying said information on said display unit;
(4) clicking a driving button placed in said user interface for instructing said retrieving and downloading module to drive a peripheral device.

20. The method of claim 19, wherein said step (1) further comprising a step of:
(A) initiating an information downloading button from said input unit.

21. The method of claim 19, wherein said step (2) further comprising a step of.
(B) initiating an information revealing button from said input unit.

22. The method of claim 19, wherein said predetermined destination of said step (2) is an address of a web page.

23. The method of claim 19, wherein said information of said step (3) is shown on an information area of said user interface.

24. The method of claim 19, wherein said information of said step (3) is shown on an advertisement window.

25. The method of claim 19, wherein said electrical device is a computer.

26. The method of claim 19, wherein said peripheral device is a scanner.
